(19) United States
(12) Patent Application Publication
(10) Pub. No.: US 2015/0234921 A1
(43) Pub. Date: Aug. 20, 2015

(54) Web-based Search Tool for Searching Literature Adverse Event Case Report

(71) Applicant: Howe Li, Basking Ridge, NJ (US)

(72) Inventor: Howe Li, Basking Ridge, NJ (US)

(21) Appl. No.: 14/185,685

(22) Filed: Feb. 20, 2014

(51) Int. Cl. G06F 17/30

(52) U.S. Cl. CPC G06F 17/30864

(57) ABSTRACT

A method of developing sematic search engine is used for searching adverse event report from literature articles, references or abstracts. The algorithm of the method comprises web-based semantic search system; medical terminology dictionaries including MedDRA, ICD-10 dictionaries, and others represented as reported medical event; product including drug, medical device, herbal medicine, and/or nutritional food dictionaries such as WHO Drug Dictionary; identifiable patient or animal; identifiable reporter (author); and a vast amount of medical/scientific literature databases. The search engine is widely used to monitor literature adverse event case report, safety related animal and human study report from abstracts and/or articles for product safety signal detection and regulatory reporting purposes worldwide.

### FIELD OF THE INVENTION

The present invention relates to a method for developing web-based search engine is used for searching adverse event/reaction report from literature articles, references or abstracts. Specifically, the invention relates to product safety signal detection and regulatory reporting from published literatures, references, or abstracts.

### BACKGROUND

Published medical literature is a well-recognized and valuable source of information about pharmaceutical products and specifically about their safety profile. Monitoring, and regulatory submission of relevant reports from the published literature fall under well established rules and regulations. Pharmaceutical and healthcare companies is required to search literature adverse event case report for their product(s) at least every other week or once a week to meet regulatory requirements and to detect/monitor product safety signal worldwide. Companies need search at least two international recognized literature index databases with consistent search criteria for their product(s) periodically. As a valid or qualified adverse event case, the report needs to meet four elements: a suspected medicinal product; an identifiable reporter; an identifiable subject; and a reported medical event/reaction. To identify valid adverse event case, safety healthcare professional have to review the report and to make a fair judgment carefully. This is why present traditional key word(s) process of searching literature adverse event is very labor intensive, costly, and widely done with broad criteria. Initially the company need set up broad search criteria and submit request and conduct literature search with narrow databases (usually two or three literature index databases). While reviewing primary searching results periodically, the majority of articles or abstracts are not valid case reports, which require safety healthcare professional to review broad primary searching result from case to case report manually. In addition, using this kind of traditional key word(s) criteria, it is impossible for the company to include the majority of literature index databases based on current method to search literature adverse event. Currently there is no friendly used tool to monitor and generate the literature report for product safety issue or profile automatically. This invention can overcome these issues.

### SUMMARY OF THE INVENTION

An object of the invention is to overcome manual, inaccurate, narrow-coverage, and labor intensive procedure to search literature adverse event and to allow the user to setup the alert for their product(s) and generate periodical report automatically. Hence, in an aspect there is provided a method for developing semantic search engine for searching literature adverse event report. The method comprises algorithm to select literature adverse event report from a mass of internationally recognized index databases of articles, references, and abstracts based on predefined criteria including adverse event term, identifiable subject, product name (International Nonproprietary Name, medical device, herbal medicine, and/or nutritional food), reporter (author), and logic relationship.

Needless to say, web-based adverse event semantic search engine and traditional key word(s) searching method to screen report of articles/abstracts are quite different process. Compared to key word(s) literature search method, the tip of the web-based adverse event semantic search system is much more sufficient, automatic, fast, accurate, systematic, wide-coverage, and low cost. Just one-step figure click will generate accurate literature adverse event case report with this method. The web-based semantic search engine includes the most of internationally recognized literature databases, which have less chance to miss literature adverse event report. Even if including all index databases, with search semantic system and setting algorithm, the system will sort and produce accurate and validated adverse event case report to reduce manual review significantly. The system is always immediately available anytime whereas the traditional way typically is submitted by inquiry every time. The web-based interface of the semantic search engine also allows cosmetic configuring search criteria by defined adverse event, product, and timeframe. In addition, the system could be pre-defined to generate the reports and alerts automatically and periodically. In summary, the invention provides a system and a computer program having features and advantages corresponding to those discussed above.

### BRIEF DESCRIPTION OF THE DRAWINGS

Having thus described the invention in general terms, reference will now be made to the accompanying drawings, which are not necessarily drawn to scale, and wherein:

FIG. 1 shows components of web-based literature adverse event searching engine

FIG. 2 shows five layers of processes in a semantic search

### DETAILED DESCRIPTION OF THE INVENTION

The present inventions now will be described more fully hereinafter with reference to the accompanying drawings, in which some examples of the embodiments of the inventions are shown. Indeed, these inventions may be embodied in many different forms and should not be construed as limited to the embodiments set forth herein; rather, these embodiments are provided by way of example so that this disclosure will satisfy applicable legal requirements. Like numbers refer to like elements throughout.

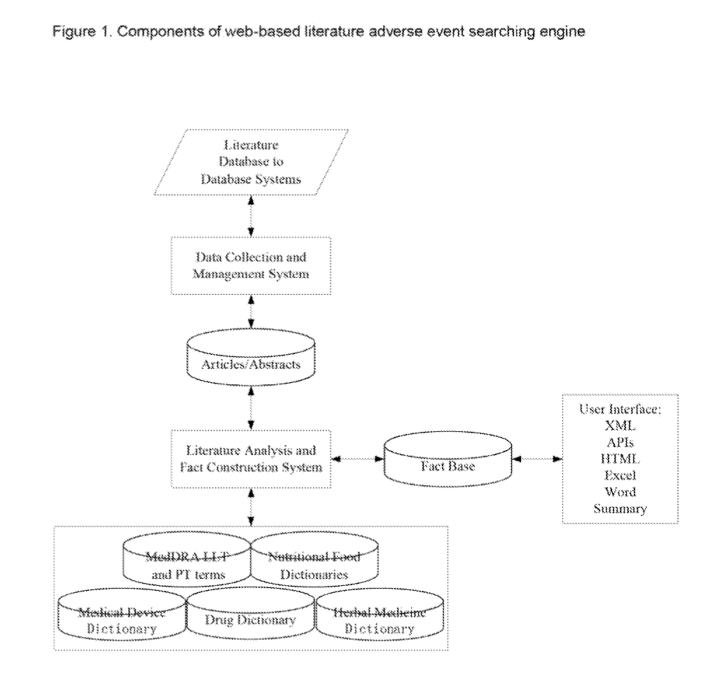

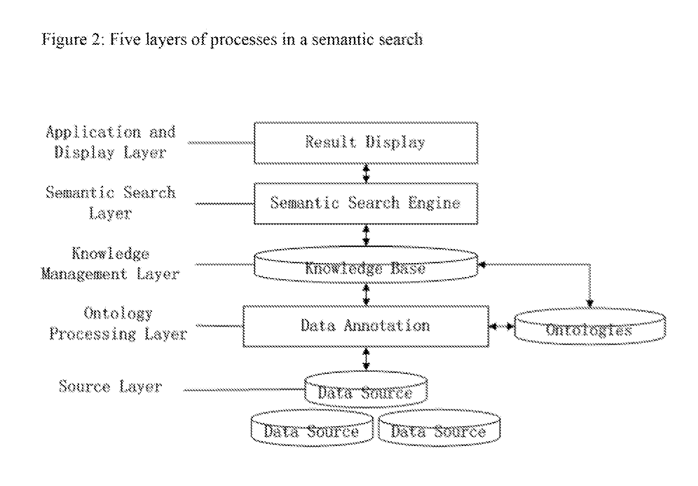

Having thus described the invention in general terms, reference will now be made to the accompanying drawings (FIGS. 1 and 2), which are not necessarily drawn to scale, and wherein:

In the FIG. 1, basically the web-based literature adverse event/reaction semantic searching engine include the following components, including literature index databases, medical dictionaries representing medical adverse event/reaction, product (drug, herb, and medical device) dictionaries representing, medical product, identifiable subject definition, and logical relationship between suspect medicinal product and adverse event/reaction etc. shown in FIG. 1. In this case, the basic four elements of qualified case should be captured in this method.
1. Literature index databases such as PubMed Medline, EMBASE, SeaSearch, BIOSIS, SEDASE, Derwent Drug File, Reactions weekly, Clin-Alert. CancerLit, ToxLine, Reactions weekly, Index Medicus, Current Contents, and/or The Science Citation Index, etc are included. These databases are very commonly used for searching literature adverse event/reaction for product safety signal detection or regulatory reporting purpose in the industry. These literatures are uploaded and collected to the hub system upon these literature index databases periodically. The system will analyze re-format each literature in certain construction and analyze these literatures. Now literatures are ready for searching to meet pre-defined criteria/algorithm described below. The pre-defined criteria/algorithm includes 1) reported adverse event/reaction; 2) identifiable subject; 3) suspect medical product; and 4) identifiable report which is author of the literature.
2. Medical terminology dictionary coding system includes WHO-ART, ICD-10, COSTART, HARTS and MedDRA. Medical dictionary is used to catch verbatim of adverse event/reaction in the literature. MedDRA is used by regulatory authorities and the pharmaceutical industry for the coding of adverse events/reactions, and the evaluation and presentation of adverse events in the clinical and post-marketing drug life cycle. Currently MedDRA is widely used for regulatory reporting at safety database. All MedDRA low level term (LLT) preferred term (PT), ICD-10 terms, and medical dictionaries are pre-loaded into the system as one of searching criteria for qualified adverse event/reaction in the literature. As long as the literature mention any verbatim term matching MedDRA either LLT, PT term, or ICD-10, or medical dictionaries, the system will capture adverse events reported in the literature.
3. Drug, medical device, herbal medicine or nutritional food dictionaries includes WHO Drug Dictionary (WHO-DD), WHO Herbal Dictionary (WHO-HD), and FDA medical device database, other medicinal product databases or dictionaries. In order to capture adverse event case report associated with use of suspect medicinal products including drug, medical device or herb in the literature, WHO Drug Dictionary (WHO-DD), WHO Herbal Dictionary (WHO-HD), and FDA medical device database and other medicinal product databases and dictionaries are pre-loaded into the system as one of searching criteria for selecting qualified suspected medical products in the literature.
4. Identifiable patient: One of components of the algorithm is identifiable patient criteria such as age information, gender, initial, adult, boy, girl, professional, patient number, date of birth, patient, or subject etc as one of searching, criteria for qualified reported subject in the literature.
5. Identifiable reporter: the author of the literature is a qualified identifiable reporter.

With the components above as basis of algorithm, while searching certain medicinal product with pre-defined timeframe at the web-based application, the output of qualified adverse event literature will be generated as the multiple formatted reports based upon user's request or definition. In the other way, the user also can search class drug or certain adverse event/reaction reported from the system.

In the FIG. 2, the present inventions are described more fully hereinafter with reference to the accompanying drawings. The semantic literature searching system has five lavers of processes in a semantic search. 1) Literature data sources including well known literature database described above. 2) Ontology processing. It parses text to a set of semantic logic forms and then annotates them to a set of RDF (Resource Description Framework) triples based on established ontologies. 3) Knowledge management. It categorizes the RDF triples according to ontolgies and stores them to knowledge base. 4) Semantic search engine. It parses and then matches query terms/algorithm to ontologies. It uses these matched results to retrieve relevant knowledge in the knowledge base. 5) Web-based application and display. It displays the searched results and pipes the results to some further applications in the different formats. The present disclosure is now described in detail with reference to a few embodiments thereof as illustrated in the accompanying drawings.

In addition, a web-based semantic search engine application provides the capacity for the users to set up their own account to build up search criteria for their own products. Under the account, the user can build up alert system to inform the user while the relevant article is published. The system can send the reports to the users automatically and periodically.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific examples of the embodiments disclosed and that modifications and other embodiments are intended to be included within the scope of the appended claims. Although specific terms are employed herein, they are used in a generic and descriptive sense only and not for purposes of limitation.

1. A method of developing sematic search engine is used for searching adverse event report from literature articles, references or abstracts. As a valid or qualified adverse event case, the report needs to meet four elements: a suspected medicinal product; an identifiable reporter; an identifiable subject; and a reported medical event/reaction. The algorithm of the method comprises web-based semantic search system as a tool; medical terminology dictionaries including MedDRA, ICD-10 dictionaries, and others represented as a reported medical event/reaction; suspected product including drug, medical device, herbal medicine, and/or nutritional food dictionaries such as WHO Drug Dictionary etc; identifiable patient or animal; identifiable reporter (author); and a vast amount of medical/scientific literature databases as literature sources. The search engine is widely used to monitor literature adverse event case report, safety related animal and human study report from abstracts and/or articles for product safety signal detection and regulatory reporting purposes worldwide.

2. The method according to claim 1, wherein component of the algorithm comprises web-based semantic search system as a platform and tool to monitor literature adverse event/reaction for product safety signal detection or regulatory reporting purpose in this method.

3. The method according to claim 1, wherein component of the algorithm comprises any kinds of medical terminology dictionary including MedDRA, ICD-10 or/and other medical dictionaries as a component of reported medical term/diagnosis to monitor literature adverse event/reaction for product safety signal detection or regulatory reporting purpose in this method.

4. The method according to claim 1, wherein component of the algorithm comprises any kinds of suspected products including drug, medical device, herbal medicine, and/or nutritional food dictionary such as, WHO Drug Dictionary (WHO-DD), WHO Herbal Dictionary (WHO-HD), and other drug, medical device, herb or food dictionaries as a component of suspected product to monitor literature adverse event/reaction for product safety signal detection or regulatory reporting purpose in this method.

5. The method according to claim 1, wherein component of the algorithm comprises internationally recognized literature index databases including PubMed Medline, EMBASE, SciSearch, BIOSIS, SEDASE, Derwent Drug File, Reactions weekly, Clin-Alert, CancerLit, ToxLine, Reactions weekly, Index Medicus, Current Contents, and/or The Science Citation Index, etc. as a component of literature sources to monitor literature adverse event/reaction for product safety signal detection or regulatory reporting purpose in this method.

6. The method according to claim 1, wherein component of the algorithm comprises identifiable patient/animal criteria such as age information, gender, initial, professional, patient number, date of birth, patient, or subject, rat, dog, rabbit, pig, mouse, monkey etc. as an identifiable subject to monitor literature adverse event/reaction for product safety signal detection or regulatory reporting purpose in this method.

7. The method according, to claim 1, wherein the combination of claims 2, 3, 4, 5, and 6 to monitor literature adverse event/reaction for product safety signal detection or regulatory reporting purpose in this method.

8. The method according to claim 1, a web-based semantic search engine application provides flexible capacity for the users to set up their own account to build up search criteria for their own products. Under the account, the user can build up alert system to inform the user while the relevant article is published. The system can send the literature searching report/result to the users automatically and periodically as defined.

9. A web-based semantic search system and literature database setting comprise five layers of processes in a semantic search. 1) Literature data sources including well known literature database described above. 2) Ontology processing. It parses text to a set of semantic logic forms and then annotates them to a set of RDF (Resource Description Framework) triples based on established ontologies. 3) Knowledge management. It categorizes the RDF triples according to ontolgoies and stores them to knowledge base. 4) Semantic search engine. It parses and then matches query terms/algorithm to ontologies. It uses these matched results to retrieve relevant knowledge in the knowledge base. 5) Web-based application and display. It displays the searched results and pipes the results to some further applications in the different formats as predefined. The present disclosure is now described in detail with reference 1 to a few embodiments thereof as illustrated in the accompanying drawings.
